(19) United States
(12) Patent Application Publication
(10) Pub. No.: US 2018/0216608 A1
(43) Pub. Date: Aug. 2, 2018

(54) SLIDING MEMBER AND SWASH PLATE COMPRESSOR

(71) Applicant: TAIHO KOGYO Co., LTd., Toyota-shi, Aichi (JP)

(72) Inventor: Tsutomu KUBOTA, Toyota-shi, Aichi (JP)

(21) Appl. No.: 15/747,638

(22) PCT Filed: Jun. 21, 2016
(86) PCT No.: PCT/JP2016/068368

§ 371 Date: Jan. 25, 2018

(30) Foreign Application Priority Data
Jul. 29, 2015 (JP) 2015-149264

(51) Int. Cl. F04B 27/08; F04B 27/10

(52) U.S. Cl. CPC F04B 27/086; F04B 27/109; F05C 2225/10; F05C 2225/06; F05C 2251/14; F05C 2203/086; F05C 2253/12; F05C 2253/18; F05C 2203/0839; F05C 2203/0882; F05C 2253/20

(57) ABSTRACT

Swash plate 3, which is a sliding member, includes base material 31, and coating layer 31 that is formed on base material 31 and has a thickness of 10 μm or more. Coating layer 31 includes binder resin 321 and solid lubricant 322, which is dispersed in binder resin 321 and has a c-axis orientation, and a relative c-axis intensity ratio of solid lubricant 321 in coating layer 32 is 80% or more.

### TECHNICAL FIELD

The present invention relates to a sliding member that has a resin coating layer in which a solid lubricant is dispersed.

### BACKGROUND ART

A sliding member is known which has a resin coating layer in which a solid lubricant is dispersed. Patent Document 1 discloses a sliding member in which a resin film layer (a resin coating layer) that has a thickness of 3 μm or less and includes a solid lubricant with a relative c-axis intensity ratio of 90% is formed in order to realize a decrease in the friction coefficient and an improvement in seizure resistance.

### CITATION LIST

### Patent Documents

Patent Document 1: JP 5391327B

### SUMMARY

### Technical Problem

For example, with a sliding member that is used in an environment with relatively little lubricant, such as a swash plate for a swash plate compressor, wear is likely to progress, and in the technique disclosed in Patent Document 1, there has been a possibility that the coating layer will wear out due to initial run-in.

On the contrary, the present invention provides a technique for achieving both the prevention of wearout of the coating layer due to initial run-in and an improvement in seizure resistance.

### Solution to Problem

The present invention provides A sliding member including: a base material; and a coating layer formed on the base material, having a thickness of 10 μm or more, wherein the coating layer includes: a binder resin; and a solid lubricant that is dispersed in the binder resin and has a c-axis orientation, and a relative c-axis intensity ratio of the solid lubricant in the coating layer is 80% or more.

The binder resin may include at least one of polyamide imide, polyamide, and polyimide.

The solid lubricant material may include at least one of MoS₂, graphite, WS₂, and h-BN.

Also, the present invention provides a swash plate compressor in which one of the above-described sliding members is used as a swash plate.

### Advantageous Effects

According to the present invention, it is possible to achieve both prevention of wearout of the coating layer due to initial run-in and an improvement in seizure resistance.

### BRIEF DESCRIPTION OF DRAWINGS

FIG. 1 is a cross-sectional schematic diagram showing a structure of compressor 1 according to an embodiment.

FIG. 2 is a diagram illustrating a structure of swash plate 3.

FIG. 3 is a schematic diagram illustrating a structure of coating layer 32.

FIG. 4 is a schematic diagram showing an oriented state of solid lubricant 322 in coating layer 32.

FIG. 5 is a flowchart illustrating a method for manufacturing swash plate 3.

FIG. 6 is a diagram showing results of measuring film thickness in Test Examples 1 to 4.

FIG. 7 is a diagram showing results of measuring orientation ratio in Test Examples 1 to 4.

FIG. 8 is a diagram showing results of measuring seizure surface pressure in Test Examples 1 to 4.

### DESCRIPTION OF REFERENCE NUMERALS

1 Compressor

2 Shaft

3 Swash plate

31 Base material

32 Coating layer

321 Binder resin

322 Solid lubricant

33 Coating layer

4 Piston

5 Shoe

### BEST MODE FOR CARRYING OUT THE INVENTION

### 1. Structure

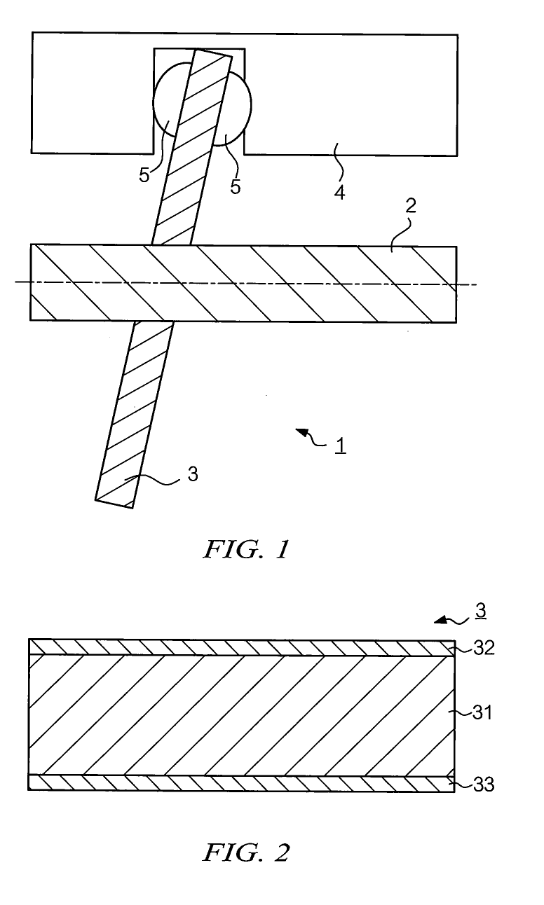

FIG. 1 is a cross-sectional schematic diagram showing a structure of compressor 1 according to an embodiment. Compressor 1 is a so-called swash plate compressor. Compressor 1 includes shaft 2, swash plate 3, piston 4, and shoes 5. Shaft 2 is supported so as to be able to rotate with respect to a housing (not shown in the figure). Swash plate 3 is fixed diagonally to a rotary axis of shaft 2. Swash plate 3 is an example of a sliding member of the present invention. Piston 4 moves reciprocally within a cylinder bore (not shown in the figure) provided in the housing. Shoes 5 are provided between swash plate 3 and piston 4 and slide with swash plate 3 and piston 4. In shoes 5, the surfaces that slide with swash plate 3 are approximately flat, and the surfaces that slide with piston 4 are dome-shaped (hemispherical). The rotation of shaft 2 is converted into the reciprocal movement of piston 4 by swash plate 3.

FIG. 2 is a diagram illustrating a structure of swash plate 3. FIG. 2 is a schematic diagram showing a structure in a cross-section taken orthogonally to the surfaces that slide with shoes 5. Swash plate 3 includes base material 31, coating layer 32, and coating layer 33. Base layer 31 has a disk shape and is formed of a metal that satisfies required characteristics, such as an iron-based, copper-based, or aluminum-based alloy. From the viewpoint of preventing adhesion with shoes 5, swash plate 3 is preferably formed of a material different from that of shoes 5.

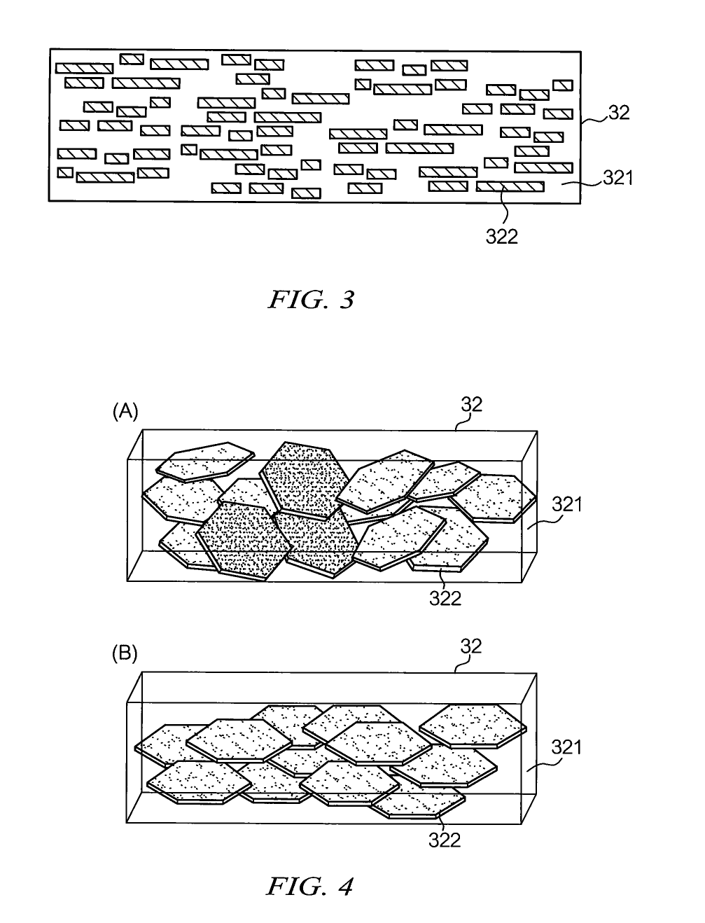

FIG. 3 is a schematic diagram illustrating a structure of coating layer 32. Coating layer 32 is provided in order to improve characteristics of the sliding surface of swash plate 3. Coating layer 32 includes binder resin 321 and solid lubricant 322. For example, coating layer 32 includes the solid lubricant in an amount of 20 to 70 vol %. The remaining portion is the binder resin. Binder resin 321 is formed of heat-curable resin, for example. For example, at least one of polyamide imide (PAI), polyamide (PA), and polyimide (PI) is used as the heat-curable resin. Solid lubricant 322 is added to improve a lubricating characteristic. A crystalline material having a c-axis orientation, for example, at least one of MoS₂, graphite (Gr), WS₂, and h-BN, is used as solid lubricant 322. The crystalline material having a c-axis orientation refers to a material having a layered crystal structure, such as a hexagonal system. Note that coating layer 32 may include hard particles in addition to solid lubricant 322. For example, at least one of an oxide, a nitride, a carbide, and a sulfide is used as the hard particles.

From the viewpoint of preventing wearout of coating layer 32, the thickness of coating layer 32 is preferably 10 μm or more, more preferably 15 μm or more, and even more preferably 20 μm or more. For example, if the thickness of coating layer 32 is less than 5 μm, coating layer 32 will wear and base layer 31 will be exposed in some cases. If base layer 31 is exposed, the friction coefficient will increase and adhesion with shoes 5 will occur, which is problematic. Also, if the film thickness of the coating layer 32 is excessively large, the seizure resistance will decrease in some cases, and therefore the film thickness is preferably 50 μm or less.

Also, from the viewpoint of improving seizure resistance, the relative c-axis intensity ratio of solid lubricant 322 in coating layer 32 is preferably 80% or more, and more preferably 85% or more. Here, the relative c-axis intensity ratio refers to the ratio of the diffraction peak intensities from cleavage planes, with respect to all diffraction peak intensities in X-ray diffraction. More specifically, the relative c-axis intensity ratio is defined as the ratio of the integrated value of diffraction peak intensities from the (002), (004), and (008) planes with respect to the integrated value of diffraction peak intensities from the (002), (004), (100), (101), (102), (103), (105), (110), and (008) planes. Although diffraction peaks from crystal planes other than the above-described nine crystal planes appear in some cases, since their peak intensities are weak, they are ignored in the calculation of the relative c-axis intensity ratio.

A state in which the relative c-axis intensity ratio is 80% or more, or in other words, in which the relative c-axis intensity ratio is high, means a state in which the crystal orientations of solid lubricant 322 are aligned in coating layer 32. The relative c-axis intensity ratio is hereinafter referred to as the “orientation ratio”, which indicates the degree to which the crystal orientations are aligned. In general, a solid lubricant has a low friction coefficient due to inter-layer sliding in the crystals, which have layer structures. The crystal orientations being aligned means that the directions in which the inter-layer sliding occurs are aligned.

FIG. 4 shows schematic diagrams showing an oriented state of solid lubricant 322 in coating layer 32. FIG. 4A shows a state in which the orientation ratio is low, and FIG. 4B shows a state in which the orientation ratio is high. In these diagrams, solid lubricant 322 is shown as thin hexagonal pieces. In the example shown in FIG. 4B, solid lubricant 322 is aligned in a direction in which the cleavage planes are approximately parallel to the sliding plane. If the orientation ratio of solid lubricant 322 is high in coating layer 32 as shown in FIG. 4B, the friction coefficient decreases and the seizure resistance improves.

The average particle diameter of solid lubricant 322 is 1 to 6 μm, for example. The average particle diameter is measured using a laser diffraction method, for example.

Coating layer 33 is formed similarly to coating layer 32.

### 2. Manufacturing Method

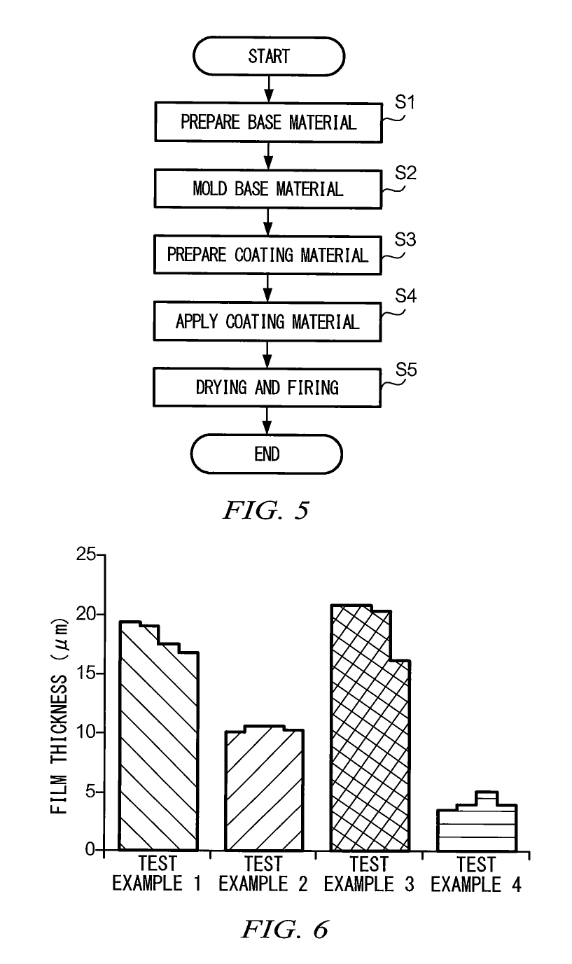

FIG. 5 is a flowchart illustrating a method for manufacturing swash plate 3. In step S1, the base material is prepared. In step S2, the base material is molded into a predetermined shape. In this example, the base material is molded into a disk shape. In order to increase adhesion between the base material and the coating layers, the surfaces of the base material may be roughened.

In step S3, coating material for forming the coating layers is prepared. First, the binder resin and the solid lubricant are mixed using a known method. The resulting mixture is diluted with a diluting agent. Anything may be used as the diluting agent, but for example, N-methylpyrrolidone (NMP) is used. The mixing ratio of the diluting agent is, for example, 30 to 70 vol % with respect to the solid content.

In step S4, the surfaces of the base material are coated with the coating material. The coating material is applied through pad printing, roll coating, or spray coating, for example. If the thickness of the coating material that can be applied in one instance is limited, two or more instances of coating may be performed. In step S5, the coating layers are dried and fired. The surface roughnesses of the coating layers are preferably 5 μmRz or less, for example.

### 3. Test Examples

Test pieces of the sliding member were produced under various conditions and their characteristics were evaluated. More specifically, multiple test pieces were produced in four segments in each of Test Examples 1 to 4. In Test Examples 1 to 4, the materials and compositions of coating layer 32 are the same. PAI was used as the binder resin and MoS₂ and graphite were used as the solid lubricant. Cast iron (FDC700) was used as the base material in Test Examples 1 to 4.

In Test Examples 1 to 4, the methods for applying the coating material for forming the coating layers and the film thicknesses of the coating layers are different. More specifically, the coating layers were formed through pad printing in Test Examples 1, 2, and 4, whereas the coating layers were formed through roll coating in Test Example 3. Regarding the film thicknesses, the film thicknesses were changed in a range of 3 to 19 μm for the test pieces to which the coating material was applied through pad printing. Seizure resistance tests were performed for Test Examples 1 to 4. Seizure resistance was tested by causing the swash plate and shoes to slide under the following conditions. The experimental conditions were obtained by envisioning the lubricating state in the compressor. Also, the unaided eye was used to check whether or not wearout of the coating layers occurred in the following experiments.

Environment: coolant+refrigerating machine oil

Rotation rate: 7200 rpm (swash plate rotation)

Load: gradually increasing (maximum 14 MPa)

Table 1 shows the characteristics of Test Examples 1 to 4 and the results of the seizure test and wearout test. Note that the manufacturing costs are also included in Table 1.

TABLE 1

| | Test Example 1 | Test Example 2 | Test Example 3 | Test Example 4 |
|---|---|---|---|---|
| Coating method | Pad printing | Pad printing | Roll coating | Pad printing |
| Film thickness | Approx. 18 | Approx. 10 | Approx. 19 | Approx. 4 |
| (μm)*1 | | | | |
| Orientation | Approx. 95 | Approx. 88 | Approx. 65 | Approx. 86 |
| ratio (%)*2 | | | | |
| Seizure surface | >14 | Approx. 14 | >14 | Approx. 5 |
| pressure (MPa)*3 | | | | |
| Wearout | Acceptable | Acceptable | Acceptable | Not acceptable |
| resistance | | | | |
| Cost | Low | Low | High | Low |

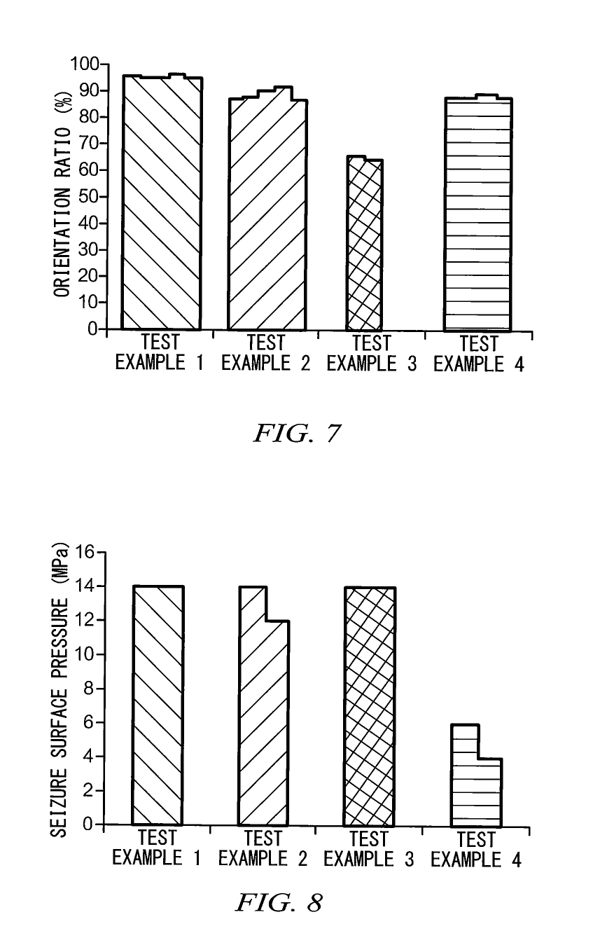

*1See FIG. 6 for detailed data on film thickness.
*2See FIG. 7 for detailed data on orientation ratio.
*3See FIG. 8 for detailed data on seizure surface pressure.

Upon comparing the samples with coating layers applied through pad printing (Test Examples 1, 2, and 4) and the samples with coating layers applied through roll coating (Test Example 3), a trend was observed in which the samples coated through pad printing had higher orientation ratios. With pad coating, the desired film thickness is obtained by layering thin films. The film thickness per layer becomes approximately equal to the size of the additive, and an effect of pressing down the additive is obtained, whereby a high orientation ratio is obtained. On the other hand, a film with a desired thickness is applied in one instance with roll coating. For this reason, if the size of the additive is used as a reference, the film thickness is thicker (thicker than with pad coating), the effect of pressing down the additive weakens, and a relatively low orientation ratio is obtained.

Upon comparing Test Examples 1 to 3 and Test Example 4, an effect was obtained in which test pieces with thin film thicknesses (Test Example 4) had lower seizure resistances compared to test pieces with thick film thicknesses (Test Examples 1 to 3). Note that although differences between seizure resistances could not be evaluated for Test Example 1 and Test Example 3 due to limitations of the testing apparatus, it is thought that the seizure surface pressure increases accompanying an increase in the orientation ratio (relative c-axis intensity), as disclosed in the specification of JP 4827680B.

Upon comparing Test Example 1 and Test Example 3, Test Example 3 had a lower manufacturing cost. This is due to the following reason. With roll coating, the accuracy is relatively low from the viewpoint of surface flatness and parallelism. With Test Example 3, cutting was performed after firing in order to increase surface flatness and parallelism. For this reason, the coating material was applied more thickly as a machining allowance, which caused a decrease in yield. With pad printing, cutting is not needed since sufficient accuracy can be obtained. Accordingly, the yield of the coating material is good, and the machining cost is low since cutting can be omitted.

Note that the sliding member according to the present invention is not limited to being used as swash plate 3 of compressor 1. The sliding member according to the present invention may be used as a sliding member that is not used in a swash plate compressor, such as a half bearing or a bushing. The materials, compositions, film thicknesses, and the like of the coating layers in the test examples are merely examples. The present example is not limited thereto.

1. A sliding member comprising:
a base material; and
a coating layer formed on the base material, having a thickness of 10 μm or more,
wherein the coating layer includes:
a binder resin; and
a solid lubricant that is dispersed in the binder resin and has a c-axis orientation, and
a relative c-axis intensity ratio of the solid lubricant in the coating layer is 80% or more.

2. The sliding member according to claim 1, wherein
the binder resin includes at least one of polyamide imide, polyamide, and polyimide.

3. The sliding member according to claim 1, wherein
the solid lubricant includes at least one of MoS₂, graphite, WS₂, and h-BN.

4. A swash plate compressor in which the sliding member according to claim 1 is used as a swash plate.
